(19) United States
(12) Patent Application Publication
(10) Pub. No.: US 2025/0289121 A1
(43) Pub. Date: Sep. 18, 2025

(54) AUTOMATED CARTON HANDLING APPARATUS AND CARTON HANDLING TOOL THEREFOR

(71) Applicant: JR Automation Technologies, LLC., Holland, MI (US)

(72) Inventor: Todd D. Vanderark, Holland, MI (US)

(21) Appl. No.: 19/064,443

(22) Filed: Feb. 26, 2025

Related U.S. Application Data
(60) Provisional application No. 63/559,568, filed on Feb. 29, 2024.

(51) Int. Cl. B25J 9/00; B25J 15/00

(52) U.S. Cl. CPC B25J 9/0093; B25J 15/0033

(57) ABSTRACT

An automated carton handling apparatus and a carton handling tool are disclosed. The apparatus includes a robotic arm and a carton handling tool coupled to the robotic arm. The carton handling tool includes a housing, with a first slide assembly and a depending arm. In some configurations, a second slide assembly may be provided to actuate the depending arm to direct and retain a carton within a cavity in the housing during transport by the robotic arm to a drop off location.

### CROSS-REFERENCE TO RELATED APPLICATION

This application claims priority to and benefit from U.S. Provisional Patent Application Ser. No. 63/559,568 filed on Feb. 29, 2024, the entire content of which is incorporated herein by reference.

### BACKGROUND OF THE DISCLOSURE

### 1. Field of the Disclosure

The disclosure relates in general to automated handling equipment, and more particularly, to an automated carton handling apparatus and carton handling tool that can be used with a carton handling apparatus.

### 2. Background Art

Automated systems for removing boxes from pallets and placing them on conveyors are known and have been used in association with material handling operations across industries. This technology automates the process of unloading pallets, enhancing efficiency and productivity in warehouses and distribution centers.

The evolution of such systems began with the introduction of basic robotic arms and conveyor belts in the last decades. Since the introduction, advancements in equipment, sensors and software have improved the capabilities of these systems.

Modern palletizing and depalletizing systems utilize sensors to detect box positions, sizes, and orientations on, for example, pallets, tables or the like. Integration with conveyor systems in many applications allows transfer of boxes from pallets to downstream processing or distribution lines.

While such systems can accommodate various box sizes, shapes, and weights, issues remain with the handling of certain types of packaging. Amongst others, there has been difficulty in the handling of cartons, which have sides that are flared outwardly and which have open tops. Some applications of such cartons include but are not limited to the types of totes that are utilized by mail services, such as the United States Postal Service.

### BRIEF DESCRIPTION OF THE DRAWINGS

The disclosure will now be described with reference to the drawings wherein:

FIG. 1 of the drawings is a schematic representation of a configuration of the automated carton handling apparatus, showing, in particular, the robotic arm, the carton handling tool attachable thereto, a carton in the carton handling tool, and a plurality of cartons;

FIG. 2 of the drawings is a perspective view of a configuration of the carton handling tool of the present disclosure;

FIG. 3 of the drawings is a cross-sectional perspective view of a configuration of the carton handling tool of the present disclosure;

FIG. 4 of the drawings is a side elevational view of a configuration of the carton handling tool of the present disclosure;

FIG. 5 of the drawings is a partial perspective view of the first slide assembly and the depending arm of the carton handling tool of the present disclosure;

FIG. 6 of the drawings is a perspective view of another configuration of the carton handling tool of the present disclosure;

FIG. 7 of the drawings is a perspective view of another configuration of the carton handling tool of the present disclosure;

FIG. 8 of the drawings is a side elevational view of another configuration of the carton handling tool of the present disclosure;

FIG. 9 of the drawings is a perspective view of a third configuration of a carton handling tool of the present disclosure;

FIG. 10 of the drawings is a partial perspective view of a third configuration of a carton handling tool of the present disclosure;

FIG. 11 of the drawings is a side elevational view of a third configuration of a carton handling tool of the present disclosure; and

FIG. 12 of the drawings is a second side elevational view of a third configuration of a carton handling tool of the present disclosure.

### DETAILED DESCRIPTION OF THE DISCLOSURE

While this disclosure is susceptible of embodiments in many different forms, there is shown in the drawings and described herein in detail specific embodiments with the understanding that the present disclosure is to be considered as an exemplification and is not intended to be limited to the embodiments illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

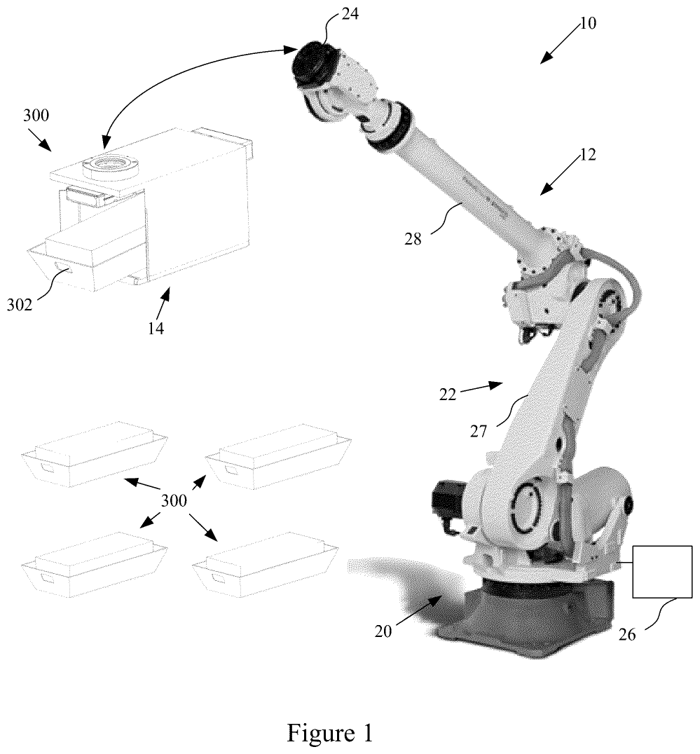

Referring now to the drawings and in particular to FIG. 1, the automated carton handling apparatus is shown generally at 10. Apparatus 10 is structurally configured to at least one of grasp, releasably retain, release and move bins, cartons, trays, totes and/or receptacles (hereinafter collectively cartons), such as carton 300. One example of a carton with which the apparatus of the present invention is well suited for handling is a conventional mail tote utilized by the USPS for carrying, moving and/or sorting mail. Such cartons generally have a rectangular base wall with sides that are generally trapezoidal in configuration such that the area of the upper opening is larger than that of the rectangular base wall, with the shorter end walls each including an opening 302 for purposes of allowing a carrier to extend fingers through the opening, and to utilize the shorter end walls as handles. Of course, the apparatus is not limited to use with such cartons. Use with other containers in a variety of shapes and sizes is contemplated.

Apparatus 10 is shown as comprising robotic arm 12 and carton handling tool 14. Robotic arm includes base 20, articulating arms 22, tool attachment 24 and control system 26. Base 20 is coupled to an outside surface which may be on the ground, or elevated from the ground. The articulating arms 22 comprise a first arm 27 and a second arm 28 which are coupled to each other in pivoted engagement. The first arm 27 is pivotably coupled to the base 20, while the base can rotate relative to the surface to which it is attached about an axis that is generally perpendicular to the ground and perpendicular to the axis by which the first arm pivots about the base, and the axis by which the second arm pivots about the first arm. The tool attachment 24 is coupled to a distal end of the second arm, and can both rotate on an axis that is perpendicular to the longitudinal axis of the second arm and on an axis that is defined by the longitudinal axis of the second arm. In the configuration shown, the robotic arm comprises a Fanuc R2000iC-125L. Of course, other robotic arms are contemplated, including arms that comprise multiple disjointed elements, and the like. The disclosure is not limited to any particular configuration of the robotic arm.

The control system 26 comprises a computing device which may include a plurality of sensors to determine both the position of the components of the robot arm, as well as components of the carton handling tool, and outside structures such as totes, conveyors, pallets and the like, as well as sensors that determine environmental conditions, including but not limited to cameras, switches and motion sensors, among others. Any number of different controllers as well as sensors are contemplated for use along with the robotic arm of the present disclosure.

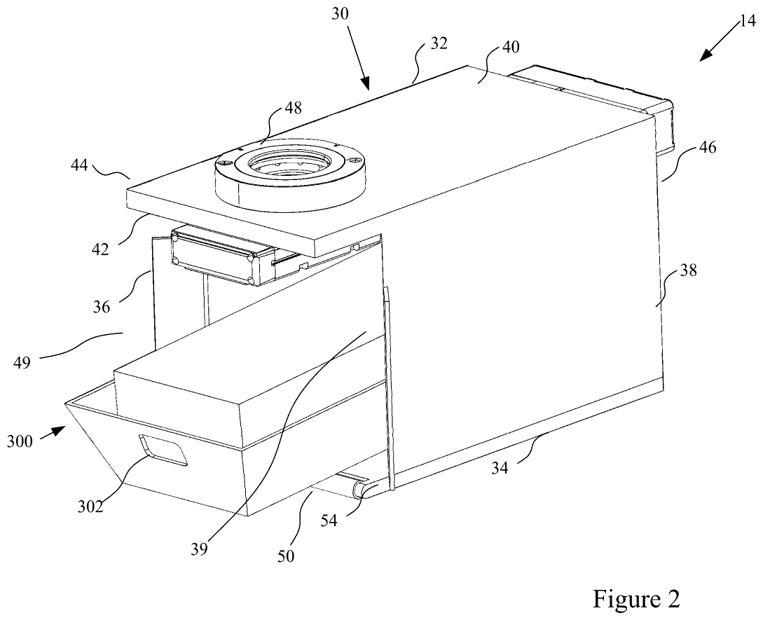

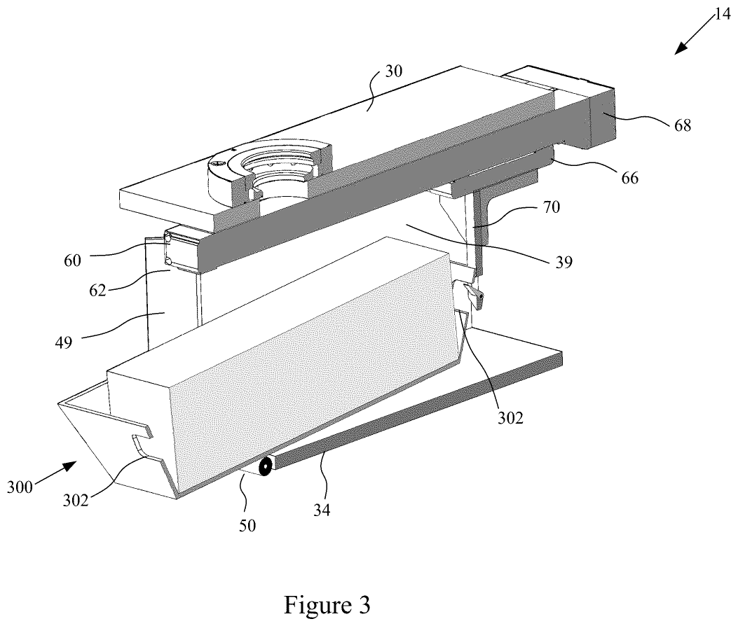

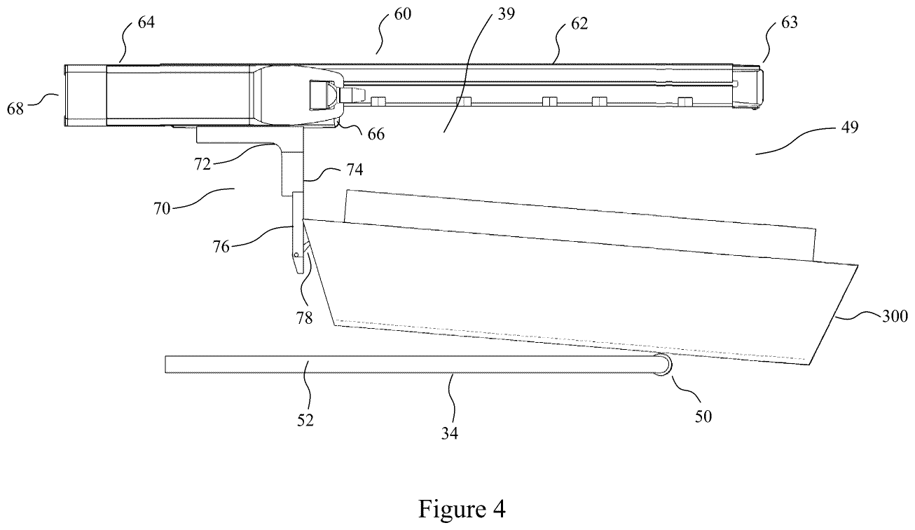

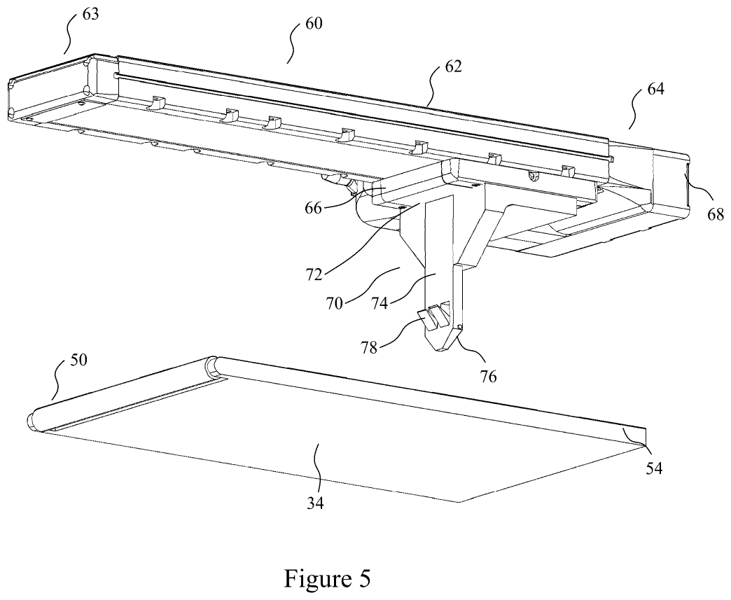

Carton handling tool 14 is shown in FIGS. 2 through 5 as comprising housing 30, first slide assembly 60 and depending arm 70. The housing may include an upper frame member 32, a lower support frame 34, a first side frame 36 and a second side frame 38. Upper frame member 32 includes a top surface 40, a bottom surface 42, a proximal end 44 and a distal end 46. Coupling 48 is presented on the top surface 40 for coupling to the tool attachment 24 in a releasable engagement. The bottom surface 42 is opposite the top surface 40. In the configuration shown, the upper frame member comprises a rectangular metal member providing a rigid coupling to the robotic arm 12.

Lower support frame 34 is shown as comprising a lower plate that generally is within the footprint of the upper frame member 32, and generally parallel thereto (or slightly orthogonal, e.g., +/−) 30°. In the configuration shown, the lower support frame 34 includes a receiving end 50 corresponding to the proximal end 44 of the upper frame housing 32. Further, the lower support frame defines a first side 52 and a second side 54 opposite the first side.

The first side frame 36 extends between the upper frame member 32 and the first side 52 of the lower support frame 34. The second side frame 38 extends between the upper frame member and the second side 54 of the lower support frame 34. Collectively, the upper frame member 32, lower support frame 34, first side frame 36 and second side frame 38 cooperatively form a cavity 39 configured to receive a carton therewithin for movement and transport by the robotic arm 12, and a receiving opening 49.

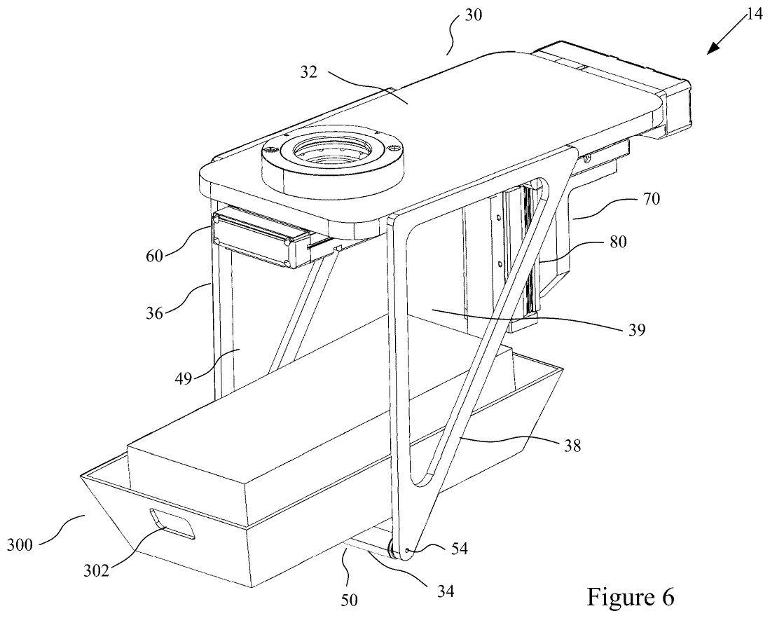

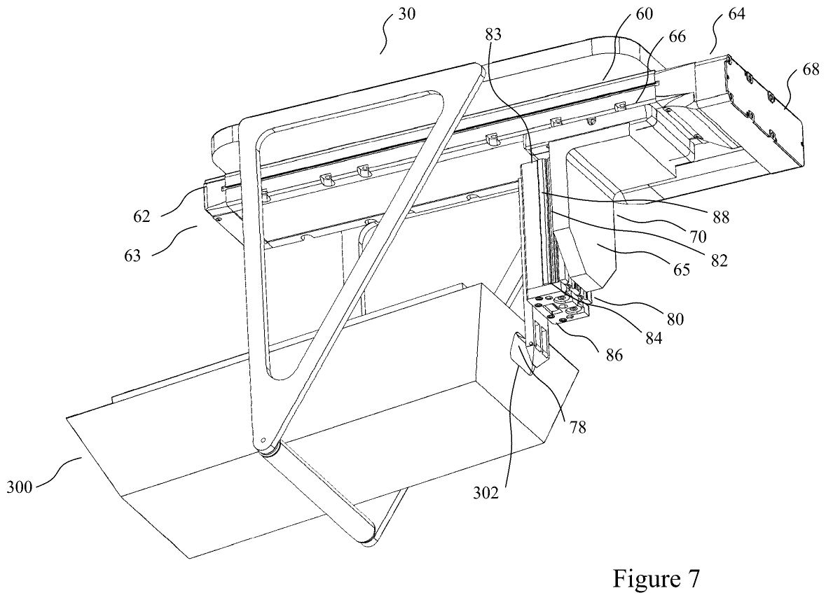

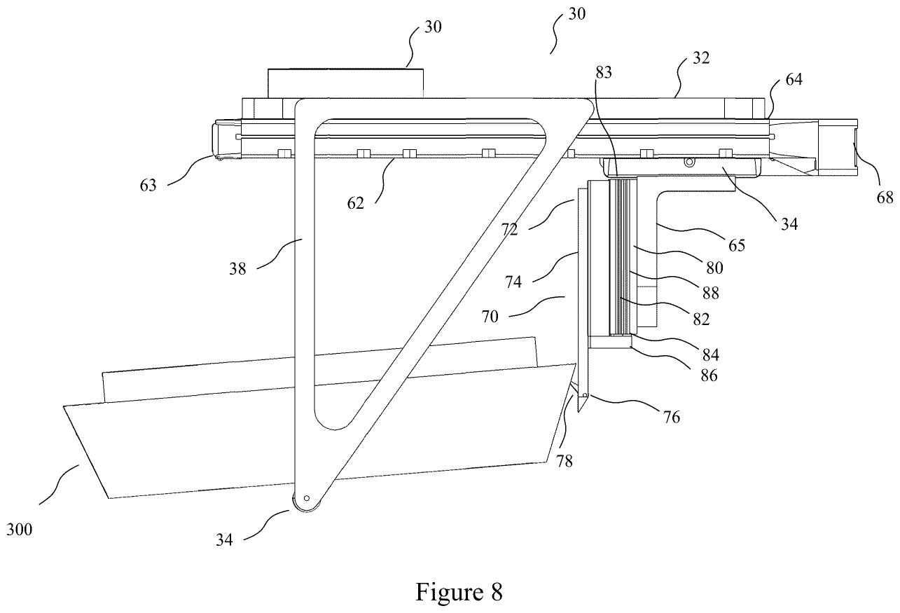

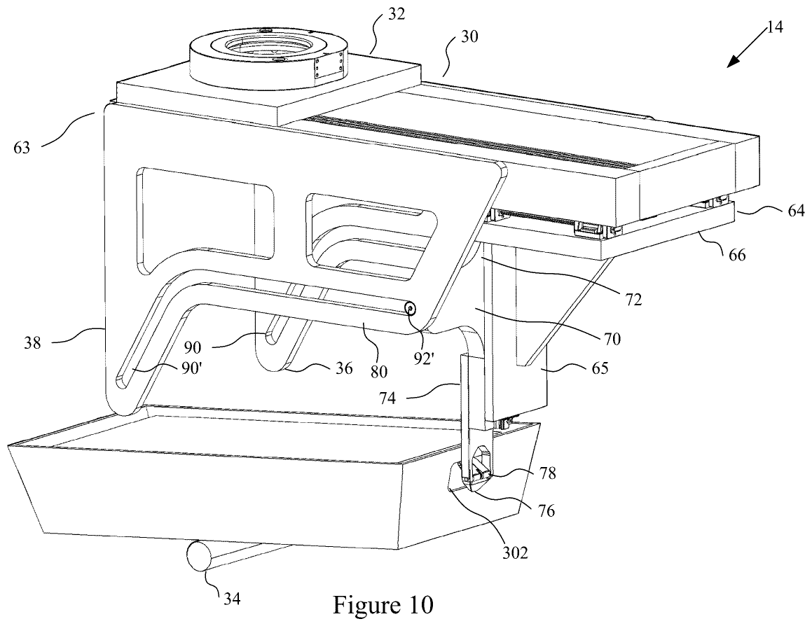

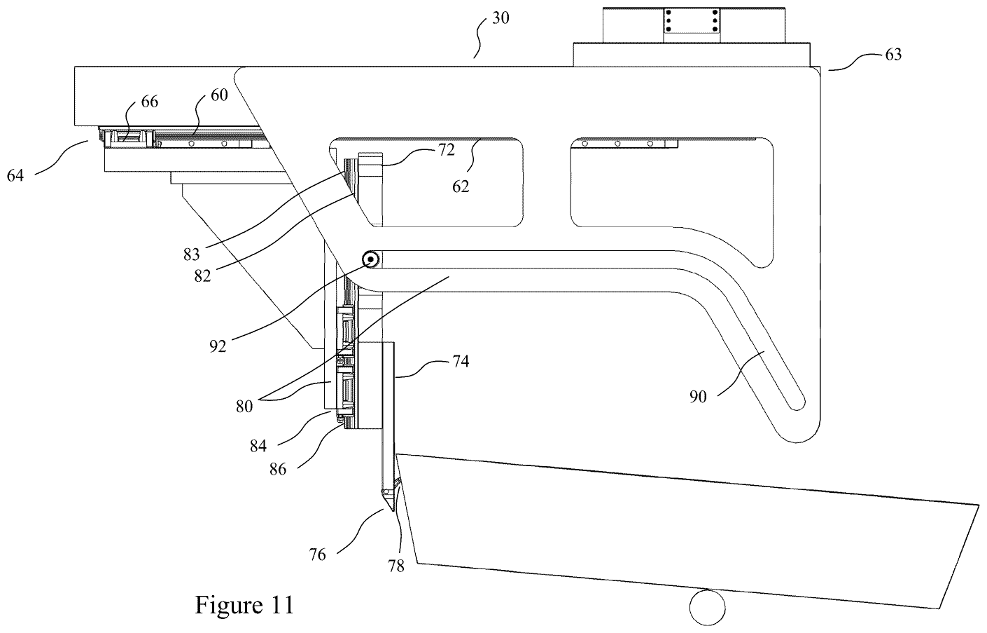

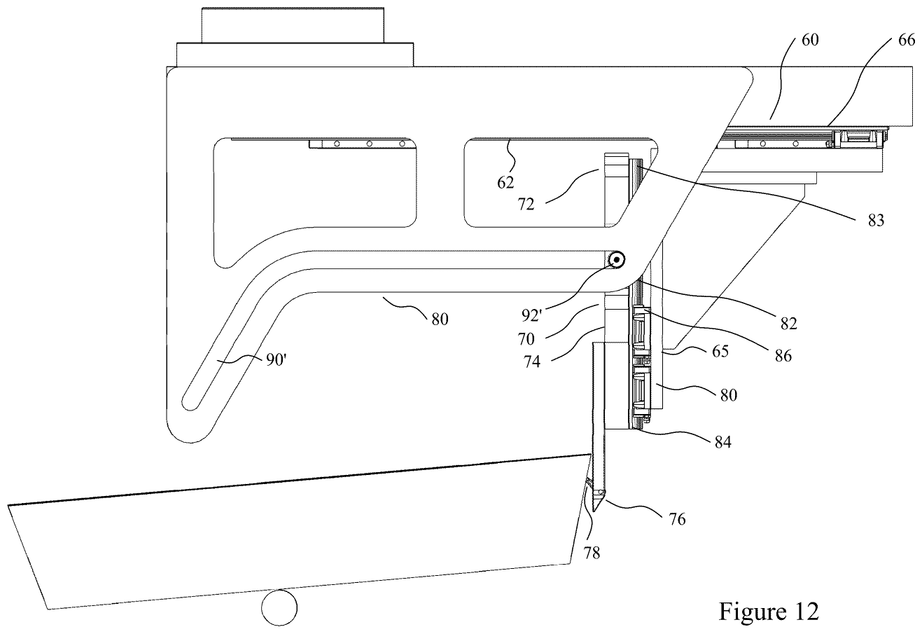

In some configurations, such as the configuration of FIGS. 6 through 12, the lower support frame 34 may comprise a bar or a cross-member instead of a plate that coextends with the upper frame member 32.

The first slide assembly 60 includes a track 62 having a carriage 66 slidably movable therealong by an actuator, such as actuator 68. Track 62 includes a proximal end 63 and distal end 64. Track 62 extends along bottom surface 42 of the upper frame member between the proximal end 44 of the upper frame member and the distal end 46 of the upper frame member such that the proximal and distal ends substantially correspond. Generally, the first slide assembly is positioned so as to bisect the cavity 39 formed by the housing.

Carriage 66 is configured to extend between the proximal end 63 and the distal end 64 of track 62. In the configuration shown, actuator 68 comprises a rodless air cylinder wherein the track defines the cylinder, and the carriage is coupled with the piston, with the motive force being provided by pneumatic force. In other configurations, the actuator may comprise a linear actuator that includes a motor driven screw within the slide and a captured nut coupled to the carriage. Other actuators, including, but not limited to mechanical, hydraulic, pneumatic, piezoelectric, coiled, telescoping, ball slide and electro-mechanical actuators are contemplated for use. Such actuators direct the carriage between the proximal and distal ends of the track 62.

Depending arm 70 is shown as comprising an upper end 72, a front face 74, a lower end 76 and an outward grasping member 78. The depending arm is coupled to the carriage 66 so as to slidably translate between the proximal and distal ends of the track. In the configuration shown, the upper end 72 is coupled to the carriage and depends therefrom into the cavity 39. The front face 74 faces the receiving opening 49, with the lower end terminating short of the lower support frame 34 so as to be spaced apart therefrom. Outward grasping member 78 extends from the front face 74 toward the receiving opening, and in the configuration defines a hook that is configured to engage an opening in a wall of the carton in a releasable engagement. It will be understood that the carriage and/or the depending arm may be slidably coupled to the housing in multiple different locations (i.e., multiple track and carriages) so as to improve the rotational stability of the depending arm throughout the movement thereof along the track 62 of the first slide assembly.

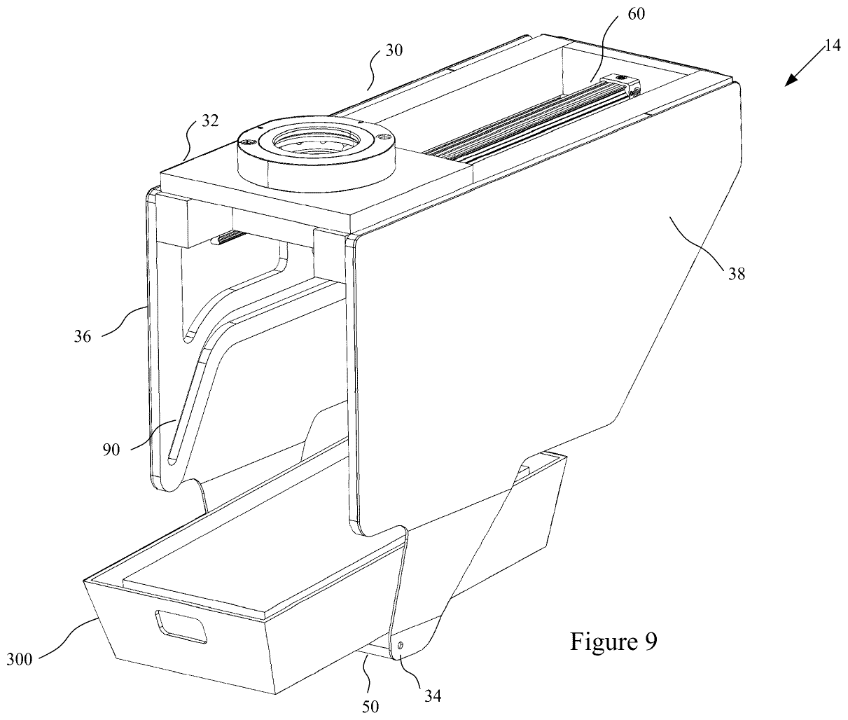

In some configurations, such as the configuration shown in FIGS. 2 through 5, the depending arm 70 is fixedly coupled to the carriage 66. In other configurations, such as the configuration shown in FIGS. 6 through 8, and the configuration shown in FIGS. 9 through 12, the depending arm may comprise multiple components such that the outward grasping member may be slidably movable relative to the carriage 66 in a direction that is substantially perpendicular to the track 62 of the first slide assembly, and in a direction toward and away from the upper frame member 32.

With particular reference to the configuration of FIGS. 6 through 8, the carton handling tool 14 further includes a second slide assembly 80. The second slide assembly includes a track 82, a carriage 86 and an actuator, such as actuator 88. The track 82 is coupled to a lower frame member 65 which is fixedly coupled to the carriage 66 and defines an upper end 83 and a lower end 84. The carriage 86 is slidably movable between the lower end and the upper end of track 82. In the configuration shown, the actuator 88 likewise comprises an actuator such as a rodless air cylinder, while the types of actuators described above with respect to the actuator of the first slide assembly 60 are contemplated for use.

The depending arm 70 is coupled to the carriage 86 of the second slide assembly so that the depending arm can be moved toward and away from the upper frame member 32. It will be understood that the first slide assembly and the second slide assembly can be actuatable at the same time resulting in movement of the carton retained by the outward grasping member 78 in both a direction between the proximal end and the distal end of the track of the first slide assembly and in a direction between the upper end and the lower end of the track of the second slide assembly.

In yet another configuration, and with particular reference to FIGS. 9 through 12, the actuator 88 can be replaced with a mechanical actuator in the form of a cam, such as cam 90 formed on or positioned proximate to the first side frame 36 and a follower, such as follower 92 extending from the depending arm 70. In the configuration shown, a pair of opposing cams 90, 90′ may be provided, with a corresponding pair of opposing followers 92, 92′ configured to interface therewith, respectively. The cam is configured to lower the outward grasping member 78 proximate to the receiving opening 49, and to raise the outward grasping member 78 away from the receiving opening. With the profile shown in FIGS. 9 through 12, the cam is configured to relatively quickly raise the outward grasping member 78 and then to remain at the raised level throughout the remaining movement of the carriage 66 toward the distal end of the track 62.

In operation, it will be understood that at least one carton, and in the configuration shown schematically in FIG. 1, a plurality of cartons, are positioned proximate to the apparatus 10. In the configuration shown, apparatus 10 is programmed, or operated to move cartons, such as carton 300. This can be done sequentially with each of the cartons as desired.

As for the apparatus, the carton handling tool is mounted to the tool attachment 24 of the robotic arm 12. Preferably, the depending arm is positioned at or near the proximal end 63 of the track 62. Additionally, where the depending arm is movable relative to the upper frame member (through the second side assembly, for example), the depending arm is directed toward the lower end 84 of the track 82 of the second slide assembly.

The first step is to utilize sensors to determine the orientation and position of the carton. Once determined, the robotic arm 12 can direct the carton handling tool 14 so that the outward grasping member 78 extends through an opening, such as the opening 302 of carton 300. Once extended through the opening, the outward grasping member 78 is moved (either through movement of the carriage 66, the carriage 86 or movement of the carton handling tool by the robotic arm, or through a combination thereof) so as to contact the upper end of the opening, and to initiate lifting of the carton by the outward grasping member 78.

Next, the carriage 66 is directed toward the distal end 64 of the track 62 so as to direct the carton into the cavity 39. At the carton enters the cavity 39 through the receiving opening 49, the base wall of the carton contacts the receiving end of the lower support frame 34 so as to support the underside of the carton. In configurations wherein the depending arm moves due to a second slide assembly, the depending arm is directed toward the upper end 83 of track 82 of the second slide assembly, lifting the portion of the carton that is retained by the depending arm toward the upper frame member of the housing 30.

Eventually, the carton enters sufficiently within the cavity 39 so as to be retained within the carton handling tool. The robotic arm 12 then moves the carton handling tool 14 to align the carton to the conveyor. This may be done after the carton has reached its final position in the carton handling tool. In other configurations, the carton can be moving relative to the cavity 39 of the carton handling tool, while the carton handling tool 14 is being directed by the robotic arm 12 to the conveyor.

Once fully aligned with the conveyor, as desired, the depending arm can be directed toward the receiving opening 49 of the carton handling tool 14 so as to direct the carton out of the cavity 39, and onto the conveyor. The movement of the depending arm relative to the carton handling tool, and the carton handling tool relative to the robotic arm, can be orchestrated so as to disconnect the outward grasping member 78 of the depending arm from the opening of the carton 300. The carton 300 can now move independent of the carton handling tool.

Once disconnected, the robotic arm 12 can redirect the carton handling tool to pick up a subsequent carton.

Advantageously, the system allows for the grasping and supporting of the carton by the carton handling tool while repositioning the carton from a supply or pick up location to a release or drop off location (i.e., from, for example, a pallet, to, for example, a conveyor or the like). The movement of the carton is guided by the opening forming the handle, with the frame supporting the base wall of the carton. In some configurations, the depending arm is configured to raise the portion of the carton to which it is connected, while the carton is directed into the cavity through the receiving opening.

The foregoing description merely explains and illustrates the disclosure, and the disclosure is not limited thereto except insofar as the appended claims are so limited, as those skilled in the art who have the disclosure before them will be able to make modifications without departing from the scope of the disclosure.

What is claimed is:

1. A carton handling tool for attachment to a robotic arm for transport, the carton handling tool being for use with cartons having an opening on a side wall, the carton handling tool comprising:
a housing including an upper frame member, a first side frame, a second side frame and a lower support frame that define a cavity for retaining a carton and a receiving opening;
at least one slide assembly; and
a depending arm comprising an upper end, a front face, a lower end and an outward grasping member extending from the front face, wherein the depending arm is slidably coupled to the housing through the at least one slide assembly and configured to move proximate to the receiving opening to cause the outward grasping member to releasably engage an opening in a wall of the carton and direct the carton through the receiving opening into the cavity to retain the carton therewithin for transport by a robotic arm to a drop off location.

2. The carton handling tool of claim 1, wherein the at least one slide assembly includes a first slide assembly having a track coupled to the housing, a carriage to which the depending arm is fixedly coupled, and an actuator that actuates the carriage to move between proximal and distal ends of the track, towards and away from the receiving opening.

3. The carton handling tool of claim 1, wherein the at least one slide assembly includes a first slide assembly and a second slide assembly, each slide assembly including a track, a carriage and an actuator, and wherein the two carriages are actuatable by the respective actuators to direct the depending arm to move in a direction between proximal and distal ends of the track of the first slide assembly and in a direction between upper and lower ends of the track of the second slide assembly.

4. The carton handling tool of claim 1, wherein the at least one slide assembly includes a first slide assembly and a second slide assembly, the first slide assembly including a track, a carriage and an actuator, and the second slide assembly including a track, a carriage and at least one pair of opposing cams, the cams formed on or proximate to the first and second side frames of the housing, the pair of opposing cams configured to interface with a corresponding pair of opposing followers to lower the outward grasping member proximate to the receiving opening and raise the outward grasping member away from the receiving opening.

5. The carton handling tool of claim 4, where in the first and second slide assemblies are actuatable at the same time resulting in movement of the outward grasping member in both a direction between the proximal and distal ends of the track of the first slide assembly and in a direction between the upper and lower ends of the track of the second assembly.

6. The carton handling tool of claim 1, further comprising a coupling on a top surface of the upper frame member of the housing for coupling to the robotic arm.

7. The carton handling tool of claim 1, wherein the underside of the carton is supported by the lower support frame during transport.

8. The carton handling tool of claim 1, wherein the outward grasping member defines a hook configured to releasably engage the opening in the wall of the carton.

9. The carton handling tool of claim 1, wherein the depending arm is further configured to move proximate to the receiving opening to direct the carton out of the cavity and cause the outward grasping member to disengage from the opening in the wall of the carton to place the carton on a conveyor.

10. The carton handling tool of claim 1, wherein the carton is a receptacle having a base wall, at least four side walls and at least one opening functioning as a handle in at least of the four side walls.

11. A method for moving a carton utilizing a carton handling tool mounted to a robotic arm, comprising:
positioning a carton handling tool proximate to a carton at a pickup location, the carton handling tool including a housing, at least one slide assembly and a depending arm having an outward grasping member;
actuating the at least one slide assembly to move the depending arm proximate to a receiving opening of the tool to cause the outward grasping member to releasably engage an opening in a wall of the carton and direct the carton through the receiving opening into a cavity formed within the housing to retain the carton therewithin for transport by a robotic arm to a drop off location; and
releasing the carton at the drop off location.

12. The method of claim 11, the at least one slide assembly includes a track coupled to the housing, a carriage to which a depending arm that includes the outward grasping member is fixedly coupled, and an actuator that actuates the carriage to move between proximal and distal ends of the track towards and away from the receiving opening.

13. The method of claim 11, wherein the at least one slide assembly includes a first slide assembly and a second slide assembly, each slide assembly including a track, a carriage and an actuator, and wherein the two carriages are actuatable by the respective actuators to direct the outward grasping member to move in a direction between proximal and distal ends of the track of the first slide assembly and in a direction between upper and lower ends of the track of the second slide assembly.

14. The method of claim 11, wherein the at least one slide assembly includes a first slide assembly and a second slide assembly, the first slide assembly including a track, a carriage and an actuator, and the second slide assembly including a track, a carriage and at least one pair of opposing cams, each cam formed on or proximate to a side frame of the housing, the pair of opposing cams configured to interface with a corresponding pair of opposing followers to lower the outward grasping member proximate to the receiving opening and raise the outward grasping member away from the receiving opening.

15. The method of claim 11, wherein releasing the carton at the drop off location includes aligning the carton to a conveyor and moving the grasping member toward the receiving opening of the tool to direct the carton out of the cavity and disengage from the opening in the wall of the carton to place the carton on the conveyor.

16. The method of claim 11, wherein the base wall of the carton contacts a lower support frame of the housing to provide support to the underside of the carton during transport.

17. The method of claim 11, wherein the outward grasping member defines a hook configured to releasably engage the opening in the wall of the carton.

18. The method of claim 11, wherein the carton is a receptacle having a base wall, at least four side walls and at least one opening functioning as a handle in at least of the four side walls.

19. A carton handling tool for attachment to a robotic arm for transport, the carton handling tool comprising:
a housing including an upper frame member, a first side frame, a second side frame and a lower support frame that define a cavity for retaining a carton and a receiving opening;
a first slide assembly having a track, a carriage and an actuator that is configured to slidably translate the carriage between proximal and distal ends of the track;
a depending arm comprising an upper end, a front face, a lower end, an outward grasping member extending from the front face and a pair of opposing followers extending from the depending arm;
a second slide assembly having a track, a carriage and a pair of opposing cams formed on or positioned proximate to the housing; the pair of opposing cams configured to interface with the corresponding pair of opposing followers to lower the outward grasping member proximate to the receiving opening causing the outward grasping member to releasably engage an opening on a wall of the carton and raise the outward grasping member away from the receiving opening to direct the carton through the receiving opening into the cavity, wherein the carriage of the first slide assembly is configured to direct the carton further into the cavity to cause the carton to be retained therewithin for transport by a robotic arm to a drop off location.

20. An automated carton handling apparatus programmed to transport a carton, the automated carton handling apparatus comprising:
a robotic arm;
a carton handling tool coupled to the robotic arm, the carton handling tool comprising a housing including an upper frame member, a first side frame, a second side frame and a lower support frame that define a cavity for retaining a carton and a receiving opening;
wherein the robotic arm is configured to utilize one or more sensors to determine the orientation and position of the carton, and direct the carton handling tool to cause an outward grasping member of a depending arm of the carton handling tool to extend through an opening of the carton and move to lift and direct the carton into the cavity through the receiving opening so as to retain the carton within the cavity for transport to a drop off location; and
wherein the robotic arm is further configured to direct the carton handling tool to align the carton to the drop off location and cause a depending arm of the tool to move toward the receiving opening to direct the carton out of the cavity and onto the drop off location and disengage the outward grasping member from the opening of the carton.
